(19) United States
(12) Patent Application Publication
(10) Pub. No.: US 2016/0162904 A1
(43) Pub. Date: Jun. 9, 2016

(54) MANAGING CUSTOMER SATISFACTION IN A NETWORKED MARKETPLACE

(71) Applicants: Nithya Chellam, Bangalore (IN); Harish K. Kumar, Chennai (IN); Suresh Karuppuchamy, Madurai (IN)

(72) Inventors: Nithya Chellam, Bangalore (IN); Harish K. Kumar, Chennai (IN); Suresh Karuppuchamy, Madurai (IN)

(21) Appl. No.: 14/562,377

(22) Filed: Dec. 5, 2014

(51) Int. Cl. G06Q 30/00

(52) U.S. Cl. CPC G06Q 30/016; G06Q 30/012

(57) ABSTRACT

Techniques for managing customer satisfaction in a network workplace are presented herein. A transaction module may be configured to retrieve an indicator that describes a transaction between a consumer and a merchant. The transaction module may compare the indicator to a set of threshold indicators and may declare the transaction unsatisfactory if the response to the indicator exceeds one of the threshold indicators. A communication module may send one or more messages to the merchant in response to declaring the transaction unsatisfactory. An incentive module may determine, based on the response from the merchant, whether the merchant will provide an incentive to the consumer. In response to the merchant not providing an incentive, the incentive module may determine a system incentive to provide to the consumer.

### TECHNICAL FIELD

The subject matter disclosed herein generally relates to the technical field of networked marketplaces and more specifically relates to increasing consumer satisfaction in response to an unsatisfactory transaction in a networked marketplace.

### BACKGROUND

As technology advances, consumers use networked marketplaces for an ever increasing variety of purchases. Items and/or services may be purchased from a wide selection of different networked marketplaces. However, consumers frequently purchase from unknown merchants, which may, on occasion, result in an unsatisfactory transaction.

There are many problems that arise for consumers when using a networked marketplace. A merchant may perform poorly, a shipping entity may perform poorly or not at all, an item or service may be defective, or the like. A consumer may associate a poor experience with a specific merchant, or with a specific shipper as a fault of the networked marketplace. A poorly performing merchant may damage a reputation of the network marketplace and may cause a consumer to look elsewhere for online shopping needs. Therefore, the networked marketplace may be motivated to manage customer satisfaction and may offer an incentive to a consumer with a bad experience. This may help retain the consumer as a customer of the networked marketplace regardless of a poorly performing merchant.

### BRIEF DESCRIPTION OF THE DRAWINGS

Some embodiments are illustrated by way of example and not limitation in the figures of the accompanying drawings.

FIG. 1 is a block diagram illustrating a system for managing customer satisfaction in a networked marketplace, in accordance with an example embodiment.

FIG. 2 is a block diagram illustrating a system for managing customer satisfaction in a networked marketplace, in accordance with an example embodiment.

FIG. 3 is a block diagram illustrating a system for managing customer satisfaction in a networked marketplace, in accordance with an example embodiment.

FIG. 4 is an illustration depicting a method for managing customer satisfaction in a networked marketplace, in accordance with an example embodiment.

FIG. 5 is an illustration depicting a method for managing customer satisfaction in a networked marketplace, in accordance with an example embodiment.

FIG. 6 is a block diagram illustrating a method for managing customer satisfaction in a networked marketplace, in accordance with an example embodiment.

FIG. 7 is a block diagram illustrating a method for managing customer satisfaction in a networked marketplace, in accordance with an example embodiment.

FIG. 8 is a block diagram illustrating a method for managing customer satisfaction in a networked marketplace, in accordance with an example embodiment.

FIG. 9 is a block diagram illustrating components of a machine, according to some example embodiments, able to read instructions from a machine-readable medium and perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example systems and methods for managing consumer satisfaction in a networked marketplace are described. In certain embodiments, a networked marketplace may include a network, a transaction system, and one or more client devices. In one example, a merchant may submit an item or service for sale using a client device. A consumer may search for the item or service using the transaction system and may purchase the item or service. Therefore, according to certain embodiments, a networked marketplace may connect merchants and consumers allowing remote consumers to purchase goods and/or services from remote merchants.

Additionally, systems described herein may retrieve an indicator that describes a transaction between a consumer and a merchant, compare the indicator to a set of predefined indicators, and declare the transaction as unsatisfactory in response to the indicator matching or exceeding one of the predefined indicators. Furthermore, a system may notify a merchant and determine an incentive to provide to the consumer based, at least in part, on a response from the merchant. A system may then transmit one or more messages to the consumer to identify the transaction and an offered incentive.

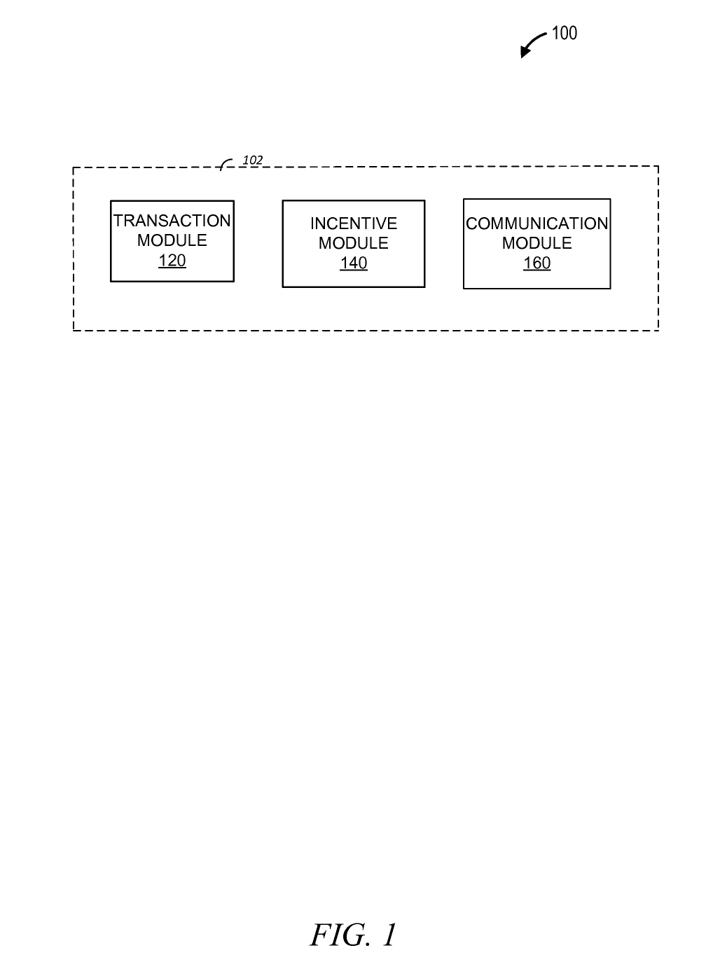

FIG. 1 is a block diagram illustrating a system 102 for managing customer satisfaction in a networked marketplace, in accordance with an example embodiment. In one embodiment the system 102 may include a transaction module 120, an incentive module 140, and a communication module 160.

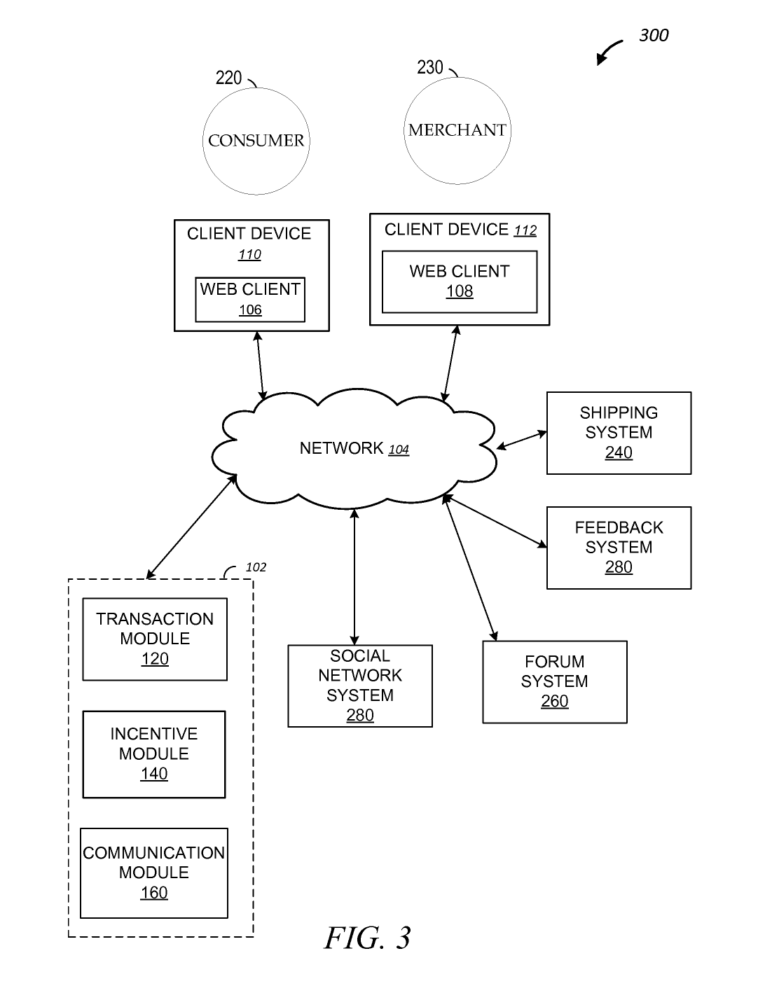

In one embodiment, the transaction module 120 may be configured to retrieve an indicator that describes a transaction between a consumer and a merchant. The transaction module 120 may receive an indicator from a shipping system 240 (illustrated in FIG. 3). For example the transaction module 120 may request a status of a particular shipment. In response, the shipping system 240 may transmit one or more indicators to the transaction module indicating a status of the shipment.

In one example, the shipping system 240 may indicate that the shipment has been lost. In response, the transaction module 120 may determine that the transaction is unsatisfactory based on the shipping status matching a predefined shipping status. In other examples, the shipping system 240 may indicate a delayed shipment, a damaged shipment, or other shipping condition that would indicate an unsatisfactory transaction.

In another example the transaction module 120 may receive an indicator by communicating with a social network system 280 (illustrated in FIG. 3). In certain embodiments, a social network system is an electronic service for building social relations among one or more users of the social network system. The social network system supports connections between users and may allow users to share interests, activities, backgrounds, experiences, or other connections, or the like. A user of the social network system may create a profile at the social network system and may identify other users with whom the user would like to connect with. In certain embodiments, the social network system may be web-based and may provide the described interactions via a web browser application. Of course, one skilled in the art may recognize other forms and/or capabilities of a social network system and this disclosure is meant to include all these.

In one example, the transaction module 120 may access a social profile (at the social network system 280) for a consumer. The transaction module 120 may poll the consumer to determine whether the consumer is satisfied with the transaction. In response to the consumer indicating dissatisfaction with the transaction, the transaction module 120 may declare the transaction as unsatisfactory. In other examples, the transaction module 120 may retrieve a review from the consumer 220, a rating from the consumer 220, and opinion from the consumer 220, or any other value that may indicate a customer satisfaction with a particular transaction or product. Therefore, in certain embodiments, the transaction module 120 may retrieve an indicator that describes a transaction between the consumer 220 and the merchant 230.

In another example the transaction module 120 may receive an indicator from the merchant 230. The merchant 230 may transmit one or more messages to the transaction module 120 indicating that the merchant 230 has not provided a conforming item. For example, the consumer 220 may have ordered a red item; however, the merchant 230 may have shipped a blue item because there were no red items available. The merchant 230 may subsequently inform the transaction module 120 that the shipped item does not conform to the consumer's 220 purchase. In response to receiving the message, the transaction module 120 may declare the transaction as unsatisfactory.

In another embodiment, the transaction module 120 may compare the indicator to one or a set of threshold indicators. In one example a set of threshold indicators for a shipping system 240 may include a failed shipment, a late shipment, an item shipped to an incorrect address, an impossible shipment, or other kind of shipment, or the like. In response to the transaction module 120 retrieving an indicator that indicates a shipment status, the transaction module 120 may compare the status to any and/or all of the threshold indicators. In response to the indicator matching any and/or all of the threshold indicators, the transaction module 120 may declare the transaction as unsatisfactory.

In another embodiment, the transaction module 120 may declare the transaction as unsatisfactory in response to the indicator exceeding one of the threshold indicators. For example, the threshold indicator may indicate that a purchased item is to be shipped within two days of the purchase. In response to a purchased item being shipped after two days of the purchase, the transaction module 120 may declare the transaction unsatisfactory because the shipping time exceeds a threshold shipping time.

In one embodiment, the indicator may be one or more posts on a forum. In one example, the transaction module 120 may retrieve an indicator from a forum system 260 (illustrated in FIG. 3). As one skilled in the art may appreciate, a forum system 260, in certain embodiments, may include a discussion site where users may converse in the form of posted messages. For example, in response to a user purchasing an item from the merchant, the transaction module 120 may monitor the user's posts via the forum system 260. In response to the user expressing dissatisfaction with the transaction, the transaction module 120 may declare the transaction unsatisfactory. In one example, the consumer may rate the transaction via the forum system 260. In response to the rating falling below a threshold rating, the transaction module 120 may declare the transaction unsatisfactory.

In another embodiment, the indicator may be a negative feedback from the consumer. In one example the transaction module 120 may retrieve an indicator from a feedback system (e.g., feedback system 280 of FIG. 3, discussed further below). For example, a feedback system 280 may include specific feedbacks for a given transaction including, but not limited to, negative feedback, neutral feedback, positive feedback, poor feedback, excellent feedback, unsatisfactory feedback, or other, or the like. Of course, one skilled in the art may appreciate other feedback indicators, and this disclosure is not limited in this regard.

In one embodiment, the transaction module 120 may compare the negative feedback to a set of threshold feedbacks. In response to the feedback exceeding one of the threshold feedbacks, or matching one of the threshold feedbacks, the transaction module 120 may declare the transaction unsatisfactory.

In another embodiment, the indicator may be a message from the consumer. In one example, the transaction module 120 may transmit a message to the consumer requesting a response. A message from the consumer may indicate a satisfaction level for the transaction. The transaction module 120 may compare the indicated satisfaction level from the consumer to a threshold satisfaction level and may declare the transaction unsatisfactory in response to the indicator exceeding the threshold satisfaction level.

In an example embodiment, the indicator may be a shipping indicator. For example, a shipping entity may indicate that a shipment for the item had occurred beyond the threshold time. In another example, the shipping entity may indicate that a shipment failed, was lost, cannot be delivered, was shipped to an incorrect address, or the like. In another example, the shipping entity may indicate that a shipment was delivered beyond a threshold time.

In another example embodiment, in response to the transaction module 120 declaring the transaction unsatisfactory, the incentive module 140 may determine, based on the response from the merchant, whether the merchant will provide an incentive to the consumer. For example, the transaction module 120 may receive a message from the merchant indicating that the merchant will offer an incentive. In certain examples, the incentive may be a full refund for the purchased item, a partial refund of the purchased item, a discount for a different item, free or reduced shipping for a subsequent purchase from the merchant, a replacement, or other incentive, or the like. Of course, one skilled in the art may appreciate other incentives that a merchant may offer to a consumer, and this disclosure is not limited this regard.

In one embodiment, an incentive to a consumer may include an item. For example, a replacement item or other item may be offered by the merchant. After the consumer provides feedback based on the item, the transaction module 120 may group feedback based on an unsatisfactory transaction with feedback based on receipt of the item by the consumer. Grouping feedbacks from the unsatisfactory transaction with another feedback for the incentive may allow other potential consumers to determine whether a merchant is willing to offer an incentive for unsatisfactory transactions. This may also further motivate consumers to continue using the network marketplace even though the consumer may have had unsatisfactory experience with one or more merchants.

In response to the merchants not providing an incentive, the incentive module 140 may determine a system incentive to provide to the consumer. In certain embodiments, a system incentive may motivate a consumer to continue using the networked marketplace without associating future actions with a specific merchant.

In one embodiment, a system incentive may include a coupon. For example, where the networked marketplace charges fees for use, the incentive module 140 may provide a coupon to purchase one item via the networked marketplace without fees.

In another embodiment, a system incentive may be a discount. For example, a discount may include a 5% reduction of a purchase price for an item or service from another merchant. The networked marketplace may reduce fees for a merchant to compensate for the system discount provided to the consumer.

In another embodiment, the incentive may be a referral. For example, the incentive module 140 may refer or recommend the consumer to one or more other merchants. In other embodiments, the incentive module 140 may provide other benefits as one skilled in the art may appreciate.

In another embodiment the incentive module 140 may determine that the merchant will not provide an incentive based on the merchant not responding to the request within the threshold period of time. In one example, the communication module 160 may send a message to the merchant requesting the merchant to provide an incentive to the consumer. The communication module 160 may wait for a response from the merchant for 7 days. In response to the merchant not responding for 7 days, the communication module 160 may notify the incentive module 140 that the merchant will not provide an incentive. Of course, other time periods or threshold values may be used and this disclosure is not limited in this regard.

In one embodiment, the message to the merchant may include an identification of the transaction. For example, the transaction may be referenced by a numeric value, a character string, or other identifier, as one skilled in the art may appreciate, and this may be included in the message.

In another embodiment, the message to the merchant may include the indicator. For example, where the transaction module 120 has determined the transaction to be unsatisfactory based on a lost shipment, the message may notify the merchant that the transaction is unsatisfactory because of the lost shipment.

In another embodiment, the message to the merchant may request the merchant to provide an incentive to the consumer. For example, the message may request the merchant to ship another item. In another example, in response to a late delivery, the message may include a request for the merchant to provide a partial refund. Of course, one skilled in the art may appreciate other ways in which a merchant may incentivize a consumer, and this disclosure is not limited in this regard.

In certain example embodiments, the communication module 160 may transmit the message to the merchant using email, text, a message on a forum, a message for a merchants account at the networked marketplace, or using another medium, or the like. Of course, one skilled in the art may appreciate other ways in which the communication module 160 may notify the merchant, and this disclosure is not limited in this regard.

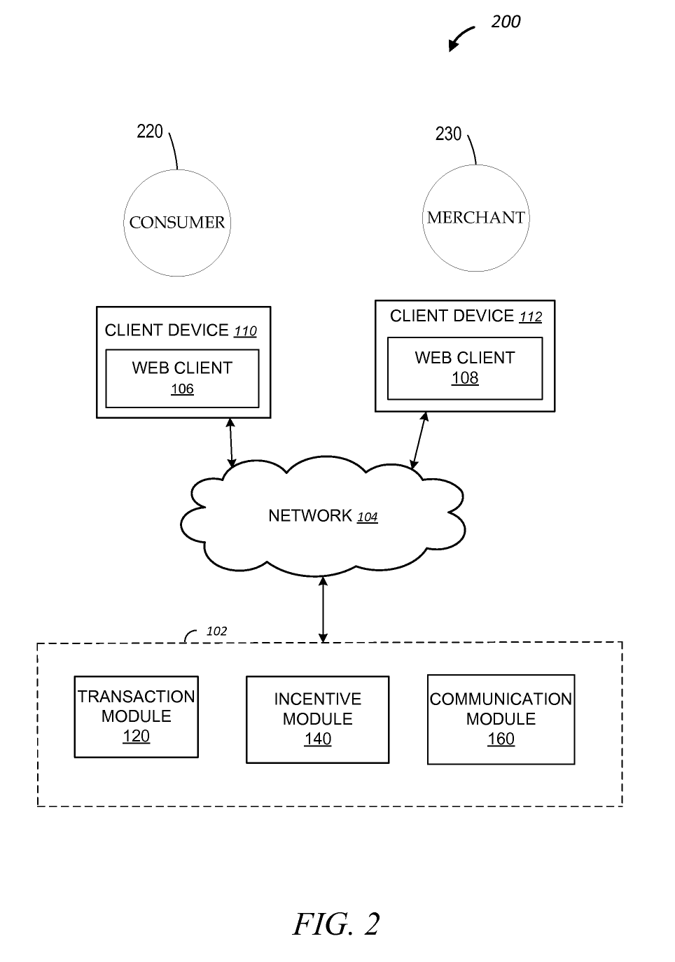

FIG. 2 is a block diagram illustrating a system 200 for managing customer satisfaction in a networked marketplace, in accordance with an example embodiment. In one embodiment the system 200 may include the transaction module 120, the incentive module 140, the communication module 160, a network 104, a client device 110, and a client device 112. The transaction module 120, the incentive module 140, and the communication module 160 may or may not be similar to those modules depicted in FIG. 1.

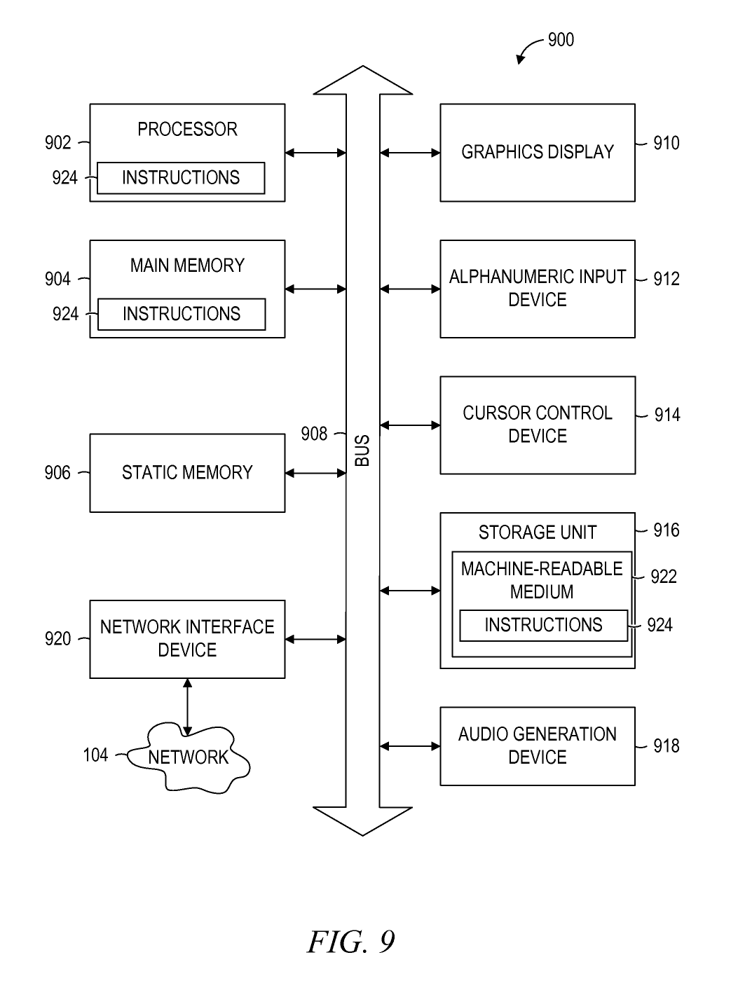

In one embodiment, the transaction module 120, the incentive module 140, and the communication module 160 may be included in a single computing device. The computing device may be implemented in a computer system, in whole or in part, as described below with respect to FIG. 9. In another embodiment the transaction module 120, the incentive module 140, and the communication module 160 may be included in separate computing devices as one skilled in the art may appreciate.

In one embodiment, a consumer 220 may communicate with the networked marketplace using the client device 110. The client device 110, in one example embodiment, may include a web client 106. Using the web client 106, the consumer 220 may initiate one or more transactions with a merchant 230.

For example, the consumer 220 may search for available items or services, may select one or more of the items or services, and/or may select an item or service for purchase using a button, or other user control provided by the networked marketplace.

A web client 106, 108, as described herein, may include an executable application that communicates with another computing device operating as part of the network 104. In one embodiment, a web client 106, 108 may include a web browser that receives web pages from a web server operating as part of the network 104.

In another embodiment, the client device 110 may include a mobile device, such as, but not limited to, a cellular phone, a laptop, a tablet, a smart phone, or other, or the like. The web client 106 may include an application executing via a processor included in the client device 110. Of course, one skilled in the art may appreciate other ways in which a client device 110, 112 may communicate with one or more systems via the network 104, and this disclosure is not limited in this regard.

In one embodiment the transaction module 120 may retrieve an indicator that describes the transaction between the consumer 220 and the merchant 230. In one embodiment the communication module 160 may monitor communications between the web client 106 and the web client 108. In one example, in response to the consumer 220 purchasing an item or service from the merchant 230, the communication module 160 may request the consumer 220 and the merchant 230 to communicate using the communication module 160. Therefore, messages between the consumer 220 and the merchant 230 may be received by the communication module 160. Messages may include indicators, selections, or the like. The communication module 160 may notify the transaction module 120 in response to indicators in a message including a complaint, disagreement, or other indicator of dissatisfaction by the consumer 220.

FIG. 3 is a block diagram illustrating a system 300 for managing customer satisfaction in a networked marketplace, in accordance with an example embodiment. In one embodiment the system 300 may include the client device 110, the client device 112, the network 104, the system 102, a shipping system 240, a feedback system 280, a forum system 260, and a social network system 280. The system 102 may or may not be similar to the system 102 depicted in FIG. 1.

In one embodiment, the system 300 may include a shipping system 240. The shipping system 240 may record and/or track a shipping time for an item purchased by the consumer 220 from the merchant 230. The transaction module 120 may retrieve the shipping time from the shipping system 240, and may compare the shipping time with a shipping time threshold. In response to the shipping time exceeding the shipping time threshold, the transaction module 120 may declare the transaction unsatisfactory.

In other embodiments, the shipping system 240 may store an indicator that indicates whether an item has been received for shipment, whether a shipment has been delayed, a time of shipping, a time when the item was delivered, intermediate shipping locations for the item, whether the item was delivered, whether the item was lost, whether the item was destroyed, or other indicator, or the like. Of course, one skilled in the art may appreciate other shipping indicators and this disclosure is meant to include all such indicators.

In one example embodiment the system 300 may include a feedback system 280. A feedback system 280 may operate as part of the networked marketplace and may be configured to receive feedback based on transactions performed using the networked marketplace. The feedback system 280 may include a set of predetermined indicators such as, but not limited to, ratings, likes, opinions, perceptions, reviews, or the like. Therefore, a consumer of goods or services (e.g., consumer 220) may select a predetermined indicator that indicates a satisfaction level for the consumer 220 based on the transaction.

In one embodiment, the transaction module 120 may retrieve the selected indicator and may compare the indicator to one or more predefined indicators. For example, a set of predefined indicators may indicate an unsatisfactory transaction. In one example, the feedback system 280 may request the consumer 220 to provide a satisfaction level on a scale of 1 to 10. The transaction module 120 may declare the transaction as unsatisfactory in response to the consumer indicating a satisfaction level of 3 or lower. In another example, the feedback system 280 may request the consumer 220 to indicate one of a negative feedback, a neutral feedback, and a positive feedback. The transaction module 120 may declare the transaction unsatisfactory in response to the consumer 220 indicating a negative feedback based on the transaction. Of course, one skilled in the art may appreciate other indicators and this disclosure is not limited in this regard.

In one embodiment the system 300 may include a forum system 260. A forum system 260 may include one or more systems and/or computing devices that receive messages from users and make them available for review by other users of the forum system 260. The forum system 260 may store and/or archive messages for historical review. The forum system 260 may categorize discussions by users in a variety of different ways. A consumer 220 may describe a transaction with a merchant 230 using the forum system 260.

In one embodiment, the transaction module 120 may retrieve one or more indicators from the forum system 260 that describe a transaction between the consumer 220 and the merchant 230. For example, the forum system 260 may request that a user posting a message indicate whether the message is a complaint. In response to a user posting a complaint, the transaction module 120 may retrieve the message and may search the post for a transaction number associated with the transaction. In response to finding a transaction number in the post (i.e. the complaint), the transaction module 120 may declare the referenced transaction unsatisfactory because of the complaint indicator associated with the message.

In another embodiment, the forum system 260 may include a rating, opinion, recommendation, or the like associated with a posted message. Similarly, the transaction module 120 may retrieve one of these indicators associated with the message and may declare the transaction unsatisfactory in response to the indicator matching or exceeding a threshold indicator. A threshold indicator, according to this embodiment, may include a rating level, an opinion level, a recommendation level, or the like.

In one embodiment, the system 300 may include a social network system 280. The social network system 280 may include similar features as a forum system 260. For example, the social network system 280 may post messages from one or more users of the social network system 280. In one example, the transaction module 120 may associate with a consumer 220 and a merchant 230 associated with a specific transaction. Because the transaction module 120 may be associated with the consumer 220, the transaction module 120 may view posts, ratings, opinions, rankings, evaluations, or the like, that the consumer 220 may provide to his/her social network profile. As previously described, the ratings, opinions, or other, may include an indicator that the transaction module 120 may compare to predefined threshold indicators. Therefore, in certain embodiments, the transaction module 120 may retrieve one or more indicators from a consumer profile on a social network system 280 and may declare a transaction as unsatisfactory in response to the transaction module 120 detecting an indicator that matches or exceeds one or more predefine threshold indicators.

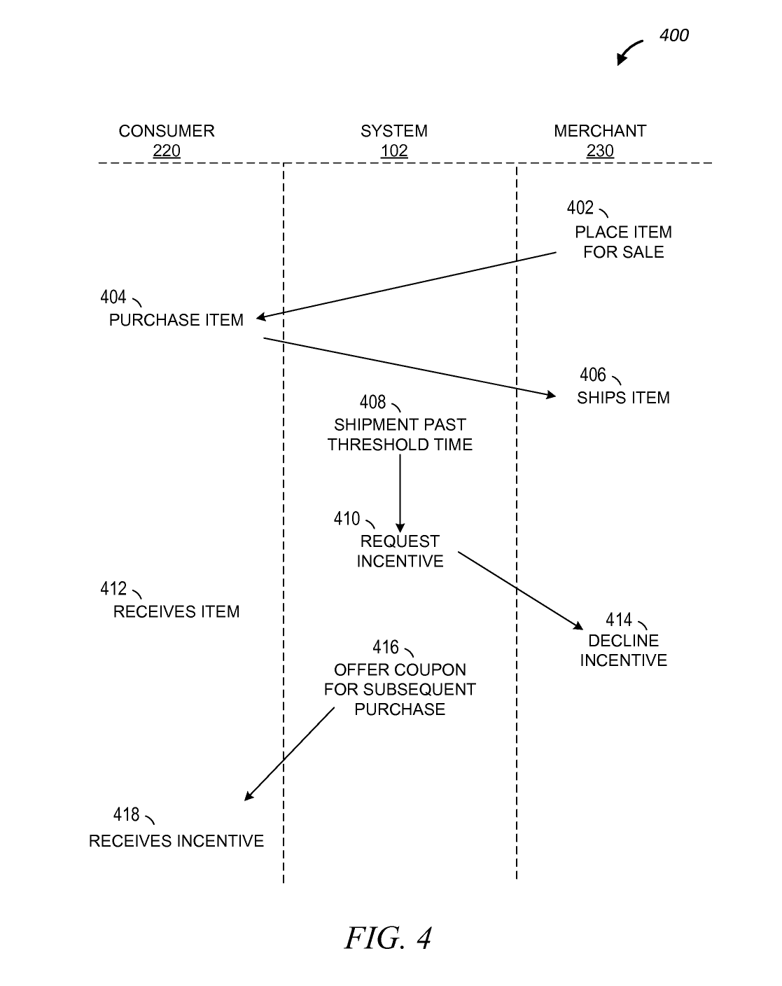

FIG. 4 is an illustration depicting a method 400 for managing customer satisfaction in a networked marketplace, in accordance with an example embodiment. In one embodiment, the system 102 may interact with a consumer 220 and a merchant 230 as illustrated in FIG. 4.

In one embodiment, a merchant 230 may place (operation 402) an item for sale. After the merchant 230 has placed the item for sale, the consumer 220 may purchase (operation 404) the item. The merchant 230 may then ship (operation 406) the item to the consumer 220 using a shipping entity. The transaction module 120 may monitor communications between the consumer 220 and the merchant 230 as previously described. The transaction module 120 may determine that the consumer 220 had purchased the item from the merchant 230 by retrieving one or more indicators from the networked marketplace.

A shipping entity, as described herein, may include an entity that accepts an item to ship to a consumer 220 and transfers possession to and/or delivers the purchased item to the consumer 220. A shipping entity may include a shipping system 240 as described in FIG. 3.

The transaction module 120 may retrieve an indicator from the shipping system 240 to determine whether the item has been shipped and/or when the item was shipped. Therefore, the transaction module 120 may determine a shipping condition of the item based, at least in part, on an indicator from the shipping system 240. The transaction module 120 may then compare the shipping condition with one or more shipping condition indicators.

In one example, the transaction module 120 may query a database for the shipping system 240 to retrieve a record that indicates a shipping condition. For example, in response to the consumer 220 purchasing an item from the merchant 230, the transaction module 120 may query the database on a daily basis to track when the item ships. When the item ships, the transaction module 120 may compare a shipping time for the item with an expected shipping time. In response to the shipping time exceeding (at operation 408) the expected shipping time, the transaction module 120 may declare the transaction unsatisfactory.

After the transaction module 120 declares a transaction unsatisfactory, the communication module 160 may send a message to the merchant 230 to request (operation 410) the merchant 230 to provide an incentive to the consumer 200. In response, the merchant 230 may decline (operation 414) to provide an incentive to the consumer 220. In one example, the merchant 230 may not respond to the message. In another example, the communication module 160 may receive a message from the merchant 230 indicating that the merchant 230 will not provide an incentive.

In order to provide an incentive to the consumer 220 based on the unsatisfactory transaction, the incentive module 140 may then determine a system incentive. For example, the system incentive module 140 may offer (at operation 416) a coupon for subsequent purchased from the networked marketplace. At operation 418, the consumer 220 may receive the incentive. Providing an incentive may increase a consumer satisfaction level and motivate the consumer 220 to continue using the networked marketplace regardless of the unsatisfactory transaction with the specific merchant 230. Furthermore, the consumer may feel that the networked marketplace may provide an incentive for future transactions in response to a poorly performing merchant.

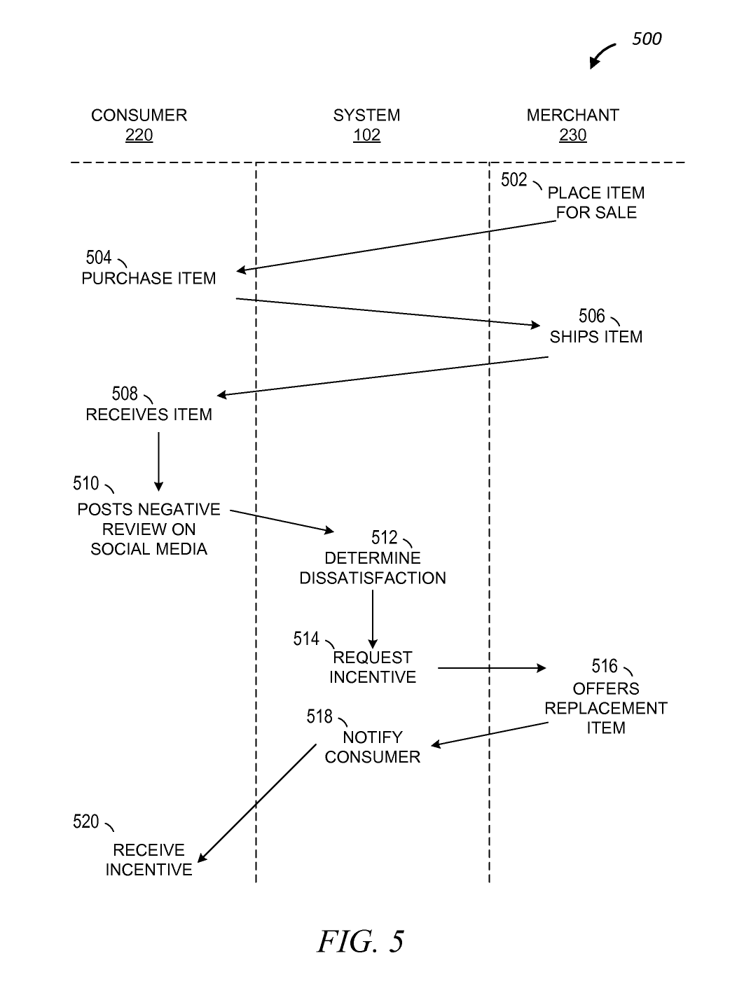

FIG. 5 is an illustration depicting a method 500 for managing customer satisfaction in a networked marketplace, in accordance with an example embodiment. The method 500 demonstrates actions by the system 102 and how the system 102 may interact with a consumer 220 and a merchant 230. The system 102 may or may not be substantially similar to the system 102 depicted in earlier figures.

In one example embodiment, a merchant 230 may place (operation 502) an item for sale using a networked marketplace as described herein. The transaction module 120 may monitor communications between the merchant 230 and the networked marketplace to determine that the merchant 230 has placed the item for sale.

A consumer 220 may locate the item using the networked marketplace and may purchase (operation 504) the item. The transaction module 120 may monitor communications between the consumer 220 and the networked marketplace to determine that the consumer 220 has purchased the item.

The merchant 230 may ship (operation 506) the item to the consumer 220 using a shipping entity. After the consumer 220 receives (operation 508) the item, the transaction module 120 may monitor the social network system 280. In one example, in order to gain access to the consumer 220's social media location, the communication module 160 may request to be a friend of the consumer 220, or associate with the consumer 220's social media account in another way as one skilled in the art may appreciate. The communication module 160 may monitor the social media for the consumer 220 for an indication from the consumer 220 regarding the transaction.

In one example, the consumer 220 may post a negative review (operation 510) on the social network system 280. In one example, the consumer 220 may rate the item on a scale from 1 star to 5 stars as one star. A threshold rating may be less than two stars. Therefore, the transaction module 120 may compare the rating to the threshold rating, and in response to the rating (one star) being less than the threshold rating, the transaction module 120 may declare the transaction unsatisfactory because the consumer 220 does not seem satisfied with the item.

In another example, the social network system 280 may ask the consumer 220 if the item is recommended. A threshold rating may include the item being recommended. In response to the consumer 220 responding that the item is not recommended, the transaction module 120 may declare (operation 512) the transaction as unsatisfactory.

In response to the transaction module 120 declaring the transaction as unsatisfactory, the incentive module 140 may request (operation 514) an incentive from the merchant 230. In one example the merchant 230 may offer (operation 516) the replacement item to the consumer 220. The communication module 160 may notify (operation 518) the consumer 220 that the merchant 230 has offered a replacement item. The consumer 220 may receive (operation 520) the incentive.

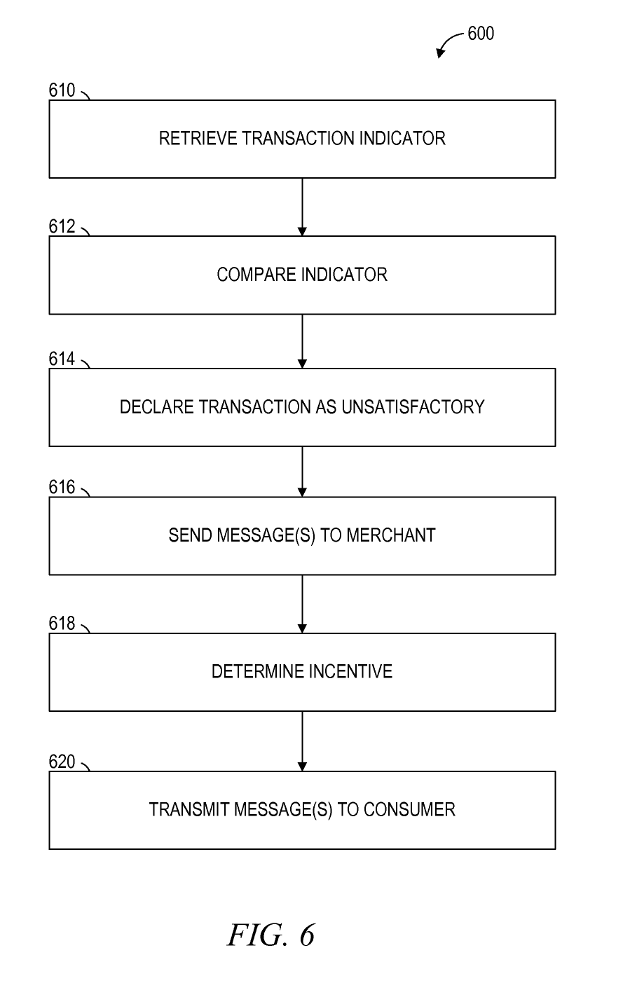

FIG. 6 is a block diagram illustrating a method 600 for managing customer satisfaction in a networked marketplace, in accordance with an example embodiment. Operations in the method 600 may be performed by the system 102, using modules described above with respect to FIGS. 1-3. As shown in FIG. 6, the method 600 includes operations 610, 612, 614, 616, 618, 620.

In one embodiment, the method 600 may begin and at operation 610 the transaction module 120 may retrieve a transaction indicator. The indicator may describe a transaction between the consumer (e.g., consumer 220) and the merchant (e.g., merchant 230). The indicator may represent a consumer satisfaction level, a shipping condition, and/or a merchant indicator of conformance. In one example, the merchant may provide a nonconforming item in response to a consumer purchasing an item using the networked marketplace. For example, the merchant may have an item, but the item may be a different color, size, pattern, or the like, from what the consumer ordered. The merchant may notify the transaction module 120 using a message, or other means as one skilled in the art may appreciate.

The method 600 may continue at operation 612 where the transaction module 120 may receive the message from the merchant and may compare an indicator in the message to a set of threshold indicators. In one example, a threshold indicator may include that the item does not conform to the consumer's request. The method 600 may continue at operation 614 where the transaction module 120 may declare the transaction as unsatisfactory due to the indicator matching an indicator indicating that the item does not conform to the consumer's request.

The method 600 may continue at operation 616 where the communication module 160 may send one or more messages to the merchant to notify the merchant that the transaction has been declared as unsatisfactory. The merchant may or may not offer an incentive to the consumer. In response to the merchant offering an incentive to the consumer, the transaction module 120 may determine, at operation 618, that the incentive to provide to the consumer is the merchant incentive. In response to the merchant declining to offer an incentive, the incentive module 140 may determine a system incentive to provide to the consumer. Furthermore, in response to the merchant not responding to the message, the incentive module 140 may determine a system incentive to provide to be consumer.

The method 600 may then continue at operation 620 where the communication module 160 may transmit a message to the consumer. The message to the consumer may identify the unsatisfactory transaction, may identify an incentive, and/or may request a response from the consumer to either accept or reject the incentive.

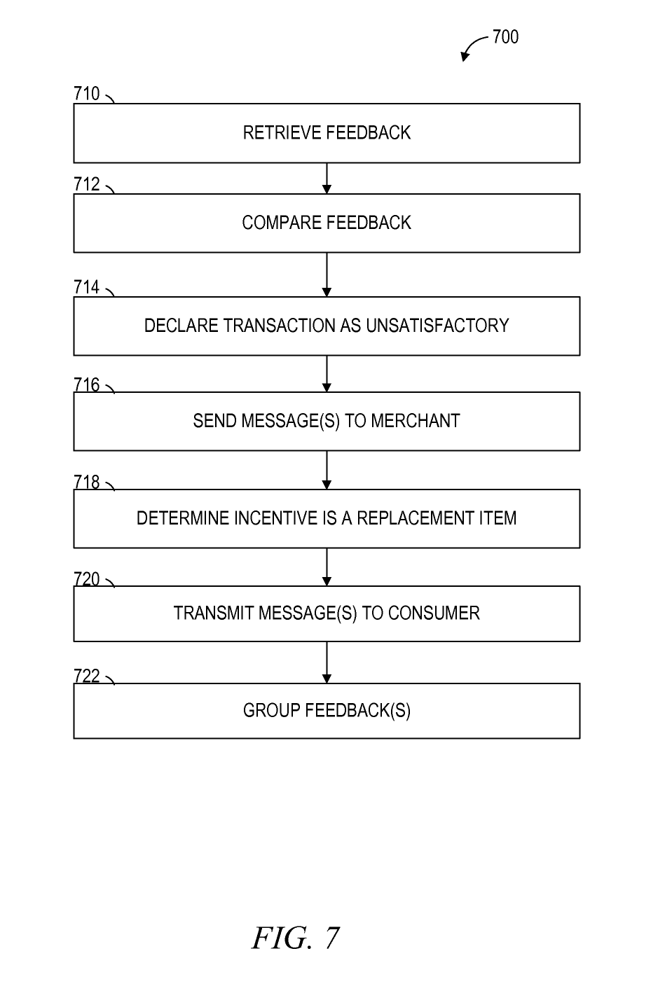

FIG. 7 is a block diagram illustrating a method 700 for managing customer satisfaction in a networked marketplace, in accordance with an example embodiment. Operations in the method 700 may be performed by the system 102, using modules described above with respect to FIGS. 1-3. As shown in FIG. 7, the method 700 includes operations 710, 712, 714, 716, 718, 720, and 722.

In one embodiment, the method 700 may begin at operation 710 with the transaction module 120 retrieving an indicator that includes feedback from the consumer regarding a transaction between a merchant and the consumer. In operation 712, the transaction module 120 may compare the feedback to one or more previously defined indicators. In response to the indicator exceeding one of the threshold indicators, the transaction module 120 may declare the transaction as unsatisfactory in operation 714.

In one example, the communication module 160 may send a message to the consumer asking the consumer if the purchased item was satisfactory. In response to the consumer indicating that the item was not satisfactory, the transaction module 120 may declare the transaction unsatisfactory.

The method 700 may then continue at operation 716 where the communication module 160 may send one or more messages to the merchant. The message to the merchant may identify the transaction, the indicator, and/or a request to provide an incentive to the consumer. In one example, the communication module 160 may send an email to the merchant requesting an incentive. The method 700 may then continue at operation 718 where the incentive module 140 may receive a message from the merchant indicating that the incentive is a replacement item.

The method 700 may then continue at operation 720 with the communication module 160 transmitting one or more messages to the consumer to inform the consumer that the merchant has identified an incentive. In response to the consumer accepting the merchant incentive (e.g., the replacement item), the merchant may provide the replacement item to the consumer. In response to the transaction module 120 receiving feedback based on the transaction involving the replacement item, the transaction module 120 may group feedback in operation 722 based on the original unsatisfactory transaction along with the transaction involving the replacement. This may allow a reviewer of feedback to determine that a prospective merchant is willing to provide incentives to correct unsatisfactory transactions.

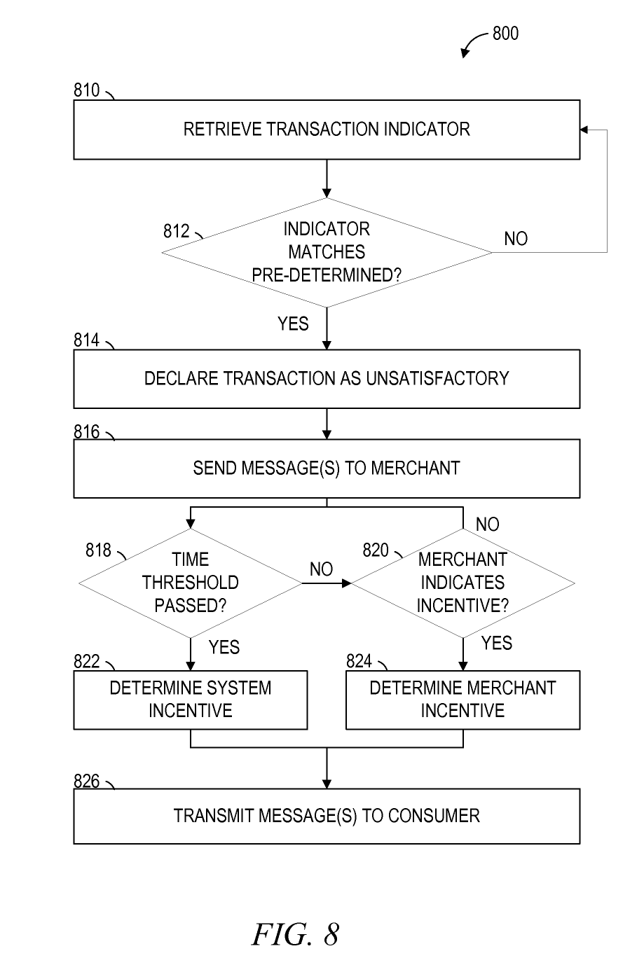

FIG. 8 is a block diagram illustrating a method 800 for managing customer satisfaction in a networked marketplace, in accordance with an example embodiment. Operations in the method 800 may be performed by the system 102, using modules described above with respect to FIGS. 1-3. As shown in FIG. 8, the method 800 includes operations 810, 812, 814, 816, 818, 820, 822, 824, and 826.

In one embodiment, the method 800 may begin at operation 810 with the transaction module 120 retrieving an indicator that describes the transaction between the consumer and the merchant. The indicator may indicate a consumer satisfaction level, a shipping condition, and/or a merchant indicator of performance as previously described.

The transaction module 120 may compare, at operation 812, the indicator to a set of threshold indicators. In response to the indicator not matching a predetermined indicator, the method 800 may continue at operation 810. In response to the indicator matching, exceeding, or falling below a predetermined indicator, the method 800 may continue at operation 814 with the transaction module 120 declaring the transaction unsatisfactory.

The method 800 may then continue at operation 816 and may send one or more messages to the merchant for the transaction. The message may include an identification of the transaction and the indicator that caused the transaction module 120 to declare the transaction as unsatisfactory. The message may be email, text, a post on a forum, a message for the merchant's profile on the networked marketplace, or other, or the like. Of course, one skilled in the art may appreciate many different ways in which the transaction module 120 may transmit a message to a merchant; this disclosure is meant to include all such ways.

The method 800 may then continue at operation 818 with the transaction module 120 determining whether a threshold time period has passed. In response to a determination that a threshold time period has not passed, the method 800 may continue at operation a 820 with the incentive module 140 determining whether the merchant has indicated an incentive. Based on the merchant not having indicated an incentive, the method 800 may continue at operation 818. In response to the communication module 160 receiving communication from the merchant indicating that the merchant is willing to provide incentive, the method 800 may continue at operation 824 with the incentive module 140 determining the incentive to be the merchant incentive.

In response to the transaction module 120 determining at operation 818 that the time period threshold has passed, the method 800 may continue at operation 822 with the incentive module 140 determining a system incentive as described herein. The method 800 may continue operation a 826 with the communication module 160 transmitting one or more messages to the consumer. The message to the consumer may identify the transaction, may identify the indicator, may identify the incentive, and/or may identify whether the incentive is a merchant incentive or a system incentive. In one example the communication module 160 may send a text message to the consumer. Of course one skilled in the art may appreciate many ways in which the communication module 160 may notify the consumer; this disclosure is not limited in this regard.

FIG. 9 is a block diagram illustrating components of a machine 900, according to some example embodiments, able to read instructions 924 from a machine-readable medium 922 and perform any one or more of the methodologies discussed herein, in whole or in part. As used herein, machine-readable medium 922 does not include signals per se. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part. In one example embodiment, the transaction module 120, the incentive module 140, and the communication module 160 may be included in the instructions 924.

In alternative embodiments, the machine 900 may operate as a standalone device or may be connected (e.g., networked) to other machines. The transaction module 120, the incentive module 140, and the communication module 160 may operate via the machine 900. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine 900 is illustrated, the term “machine” shall also be taken to include any collection of machines that individually or jointly execute the instructions 924 to perform all or part of any one or more of the methodologies discussed herein. Therefore, in certain embodiments, the various modules described herein, may be executed on different machines operating as part of the system 102.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

In one example, the transaction module 120 may be operated by the processor 902, and the transaction module 120 may store indicators, predefined indicators, retrieved indicators, or the like, in the main memory 904 and/or static memory 906. In another example, the transaction module 120 may communicate with client devices 110, 112, the shipping system 240, the feedback system 280, the forum system 260, and/or the social network system 280 using the network interface device 920.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor 902's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 104 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components (not shown) (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non exclusive “or,” unless specifically stated otherwise.

1. A computer system comprising:
a processor;
a memory device holding an instruction set executable on the processor to cause the computer system to perform operations comprising:
retrieving an indicator that describes a transaction between a consumer and a merchant, the indicator selected from the group consisting of a consumer satisfaction level, a shipping condition, and a merchant indicator of conformance;
comparing the indicator to at least one threshold indicator;
declaring the transaction as unsatisfactory in response to the indicator exceeding one of the threshold indicators;
sending one or more messages to the merchant in response to declaring the transaction as unsatisfactory, the messages comprising an identification of the transaction, the indicator, and a request to provide an incentive to the consumer;
determining, based on a response from the merchant, whether the merchant will provide the incentive to the consumer and, in response to the merchant not providing the incentive, determining a system incentive to provide to the consumer; and
transmitting to the consumer one or more messages comprising an identification of the transaction, the indicator, and one of an identification of the incentive from the merchant and the system incentive.

2. The computer system as in claim 1, wherein the determining further comprises determining that the merchant will not provide the incentive based on the merchant not responding to the request within a threshold period of time.

3. The computer system as in claim 1, wherein the indicator comprises the consumer satisfaction level, the indicator comprising a negative feedback from the consumer, the operations further comprising removing the negative feedback in response to the consumer indicating acceptance of the incentive.

4. The computer system as in claim 1, wherein the response from the merchant indicates the incentive is a replacement item, the operations further comprise grouping feedback based on the unsatisfactory transaction with feedback based on receipt of the replacement item by the consumer.

5. The computer system as in claim 1, wherein the consumer satisfaction level is based on one of a post on a forum, a negative feedback, and a message, and the shipping condition is selected from the group consisting of shipment past a threshold time period and a shipping failure.

6. The computer system as in claim 1, wherein the incentive provided by the merchant is selected from the group consisting of free shipping on a subsequent transaction, a full refund, a refund of fees, a partial refund, and a replacement item, and the system incentive is selected from the group consisting of a coupon, and a discount.

7. The computer system as in claim 1, wherein one of the one or more messages to the merchant is selected from the group consisting of an email, a text message, an HTML document, a post on a forum, and a message for a consumer's account.

8. A computer-implemented method comprising:
retrieving an indicator that describes a transaction between a consumer and a merchant, the indicator selected from the group consisting of a consumer satisfaction level, a shipping condition, and a merchant indicator of conformance;
comparing the indicator to at least one threshold indicator;
declaring the transaction as unsatisfactory in response to the indicator exceeding one of the threshold indicators;
sending one or more messages to the merchant in response to declaring the transaction as unsatisfactory, the messages comprising an identification of the transaction, the indicator, and a request to provide an incentive to the consumer;
determining, based on a response from the merchant, whether the merchant will provide the incentive to the consumer and, in response to the merchant not providing the incentive, determining a system incentive to provide to the consumer; and
transmitting to the consumer one or more messages comprising an identification of the transaction, the indicator, and one of an identification of the incentive from the merchant and the system incentive.

9. The computer-implemented method as in claim 8, wherein the determining further comprises determining that the merchant will not provide the incentive based on the merchant not responding to the request within a threshold period of time

10. The computer-implemented method as in claim 8, wherein the indicator comprises the consumer satisfaction level, the indicator comprising a negative feedback from the consumer, the operations further comprising removing the negative feedback in response to the consumer indicating acceptance of the incentive.

11. The computer-implemented method as in claim 8, wherein the response from the merchant indicates the incentive is a replacement item, the operations further comprise grouping feedback based on the unsatisfactory transaction with feedback based on receipt of the replacement item by the consumer.

12. The computer-implemented method as in claim 8, wherein the consumer satisfaction level is based on one of a post on a forum, a negative feedback, and a message, and the shipping condition is selected from the group consisting of shipment past a threshold time period and a shipping failure.

13. The computer-implemented method as in claim 8, wherein the incentive provided by the merchant is selected from the group consisting of free shipping on a subsequent transaction, a full refund, a refund of fees, a partial refund, and a replacement item, and the system incentive is selected from the group consisting of a coupon, and a discount.

14. The computer-implemented method as in claim 8, wherein one of the one or more messages to the merchant is selected from the group consisting of an email, a text message, an HTML document, a post on a forum, and a message for a consumer's account.

15. A machine-readable medium storing executable instructions thereon, which, when executed by a processor, cause the processor to perform operations including:
retrieving an indicator that describes a transaction between a consumer and a merchant, the indicator selected from the group consisting of a consumer satisfaction level, a shipping condition, and a merchant indicator of conformance;
comparing the indicator to at least one threshold indicators;
declaring the transaction as unsatisfactory in response to the indicator exceeding one of the threshold indicators;
sending one or more messages to the merchant in response to declaring the transaction as unsatisfactory, the messages comprising an identification of the transaction, the indicator, and a request to provide an incentive to the consumer;
determining, based on a response from the merchant, whether the merchant will provide the incentive to the consumer and, in response to the merchant not providing the incentive, determining a system incentive to provide to the consumer; and
transmitting to the consumer one or more messages comprising an identification of the transaction, the indicator, and one of an identification of the incentive from the merchant and the system incentive.

16. The machine-readable medium as in claim 15, wherein the determining further comprises determining that the merchant will not provide the incentive based on the merchant not responding to the request within a threshold period of time.

17. The machine-readable medium as in claim 15, wherein the indicator comprises the consumer satisfaction level, the indicator comprising a negative feedback from the consumer, the operations further comprising removing the negative feedback in response to the consumer indicating acceptance of the incentive.

18. The machine-readable medium as in claim 15, wherein the response from the merchant indicates the incentive is a replacement item, the operations further comprise grouping feedback based on the unsatisfactory transaction with feedback based on receipt of the replacement item by the consumer.

19. The machine-readable medium as in claim 15, wherein the consumer satisfaction level is based on one of a post on a forum, a negative feedback, and a message, and the shipping condition is selected from the group consisting of shipment past a threshold time period and a shipping failure.

20. The machine-readable medium as in claim 15, wherein the incentive provided by the merchant is selected from the group consisting of free shipping on a subsequent transaction, a full refund, a refund of fees, a partial refund, and a replacement item, and the system incentive is selected from the group consisting of a coupon, and a discount.
